(19) United States
(12) Patent Application Publication
(10) Pub. No.: US 2004/0137984 A1
(43) Pub. Date: Jul. 15, 2004

(54) Interactive gamepad device and game providing means of learning musical pieces and songs

(76) Inventor: Hal C. Salter, Seffner, FL (US)

Correspondence Address: Michael W. Starkweather, Jones, Waldo, Holbrook & McDonough, Suite 1500, 170 South Main Street, Salt Lake City, UT, 84101, US

(21) Appl. No.: 10/338,959

(22) Filed: Jan. 9, 2003

(51) Int. Cl. G06F 17/00

(52) U.S. Cl. 463/35

(57) ABSTRACT

A process for interpreting MIDI files into a computer video game, which can be generated with software for a personal computer, a personal digital assistant, or similar device, or with a hardware component that interfaces directly with a TV and input gamepad. The object is to strike the appropriate tongue on the attached gamepad as a game object, displayed on a graphical user interface (GUI), touches a graphic representing the correct piano key on a virtual piano keyboard. MIDI files storing musical notation and other information generate unique game fields and objects, whereby game objects stream upward or downward toward a virtual piano keyboard. If streaming upwards, then the game objects and a field of play may morph into a musical staff turned vertically (ninety (90) degrees clockwise) to put the pitch axis parallel with the virtual piano keyboard layout with moving musical notation. The virtual piano keyboard and direction of streaming game objects are thus parallel to the player's gamepad. The virtual piano keyboard graphic later rotates counter-clockwise ninety (90) degrees and morphs into moving standard musical notation. Game objects are spaced proportionate to the melodic, and rhythmic structure to facilitate interpretation of relative timing in game play, and move toward the virtual piano keyboard in tempo of music, allowing visual and audio anticipation and precise rhythmic play by the user. The game keeps track of hits and misses, generating a score and a musical map for review, and allows the game objects to be numbered for fingering clues.

### CROSS REFERENCE TO RELATED APPLICATIONS

This application claims priority from and is related to U.S. Provisional Application Serial No. 60/349,274, filed Jan. 9, 2002, entitled “AN INTERACTIVE GAMEPAD DEVICE AND GAME PROVIDING MEANS OF LEARNING MUSICAL PIECES AND SONGS”, by inventor Hal C. Salter, and U.S. Non-Provisional application Ser. No. 10/273,353, filed Oct. 18, 2002, entitled “AN INTERACTIVE GAME PROVIDING INSTRUCTION IN MUSICAL NOTATION AND IN LEARNING AN INSTRUMENT”, by inventor Hal C. Salter, which claims priority from U.S. Provisional Application Serial No. 60/347,554, filed Oct. 20, 2001, entitled “AN INTERACTIVE GAME PROVIDING INSTRUCTION IN READING MUSICAL NOTATION,” by inventor Hal C. Salter. The contents of these applications are hereby incorporated herein by reference in their entirety.

### COPYRIGHT NOTICE

At least a portion of the disclosure of this patent document contains material that is subject to Copyright protection. The Copyright owner has no objection to the facsimile reproduction by any one of the patent disclosure, as it appears in the Patent and Trademark Office patent files or records, but otherwise reserves all Copyright rights whatsoever.

### CROSS REFERENCE TO CD-ROM APPENDIX

This application contains an Appendix comprising one (1) CD-ROM containing specifications of computer programs used to carry out the invention disclosed herein, as well as other information useful in understanding the present disclosure. The available written contents of the CD-ROM are described in more detail in paper Appendix A attached to this document. The contents of the CD-ROM, which are comprised of written software and demonstration, are incorporated into this disclosure by reference in their entirety as if they were set forth completely within the text of this application.

### FIELD OF THE INVENTION

The present invention relates generally to an interactive game and game input device, and more particularly to a process for interpreting or compiling MIDI or other standard music files into an interactive game for use with the game input device that instructs its user in musical notation, and in playing songs, while playing the game.

### BACKGROUND OF THE INVENTION

MIDI technology has been a stable source of piano and music sequencing programs for editing, printing, playing and composing music for almost twenty years. Some early, relatively primitive music and piano tutorial programs, as well as some games, have resulted from this technology. For example, some types of computer aided instruction, including piano instruction, have been used in the home market for several years. However, using a more specific example, computer aided instruction for use with the kalimba, also called thumb pianos, gourd pianos, mbiras, sansas, and other indigenous names, has been lacking. These metallophonic instruments originated in Africa and vary widely in appearance, size, materials, and tuning, but usually consist of from 4 to 20 metal tongues mounted across a bridge attached to a board or resonator. Plucked with fingers or thumbs, these instruments produce a percussive music in predetermined tones.

In the general area of music instruction, primarily targeted at piano instruction, the computer has been widely used to provide a student with an interactive view of musical notation, where the student can press a key on the accompanying electronic piano and it will light up the note, or the note will light up and a drawing will indicate which key he should press. Other systems have a series of lights or fingering illustrations to attempt to communicate to the user which key should be played next. These programs and systems, while allowing the student to practice and obtain feedback, generally fail to involve musical novices sufficiently, especially with regard to rhythm. Several typing tutorials have enjoyed great success using such methods, but piano and music tutorials have not been as successful, due to several significant problems inherent with the subject. More particularly, however, none of these methods can be specifically applied to the skills required to play the kalimba or any remotely similar instruments.

Examples of prior patents in the general area of music instruction are outlined below. Each of these references is herein incorporated by reference in their entirety for their supporting teachings.

U.S. Pat. No. 4,416,182 to Wise, et al. discloses a keyboard teaching device for the self-instruction of a student of keyboard musical instruments. They system enables the student to correlate the positions of the keys on a musical instrument keyboard with the positions of the notes on a musical scale. A keyboard having a plurality of keys corresponding to the notes of a musical scale generate a first set of control signals in an initialization or set-up mode and key-note correlation signals in an instruction or game mode. There is at least one storage element storing a predetermined combination of logical signals providing a source for a pseudo random sequence of one or more notes over a predetermined range in the game mode. The system generates a second set of control signals in response to the actuation of one or more keys in either game mode and a mechanism for generating audio tones and displaying video images in accordance with the first and second sets of control signals enables a student to visually and audibly check his or her selection of one or more keys.

U.S. Pat. No. 5,183,398 to Monte, et al. discloses an apparatus and method for instruction of a student which includes interactive guidance of the student through a series of lesson frames. This disclosure provides the student with a keyboard having a plurality of keys corresponding to the notes of a musical scale and generates a key relation signal in response to each depressed or released key. A video display and an audio tone generator associated therewith enables the student to respond to the visually displayed images and audio tones by selecting one or more of the keys on the keyboard. The student is presented with a lesson frame representing an instructional activity requiring a response by the student on the keyboard. The student keyboard response is compared with a performance standard and an absolute performance evaluation result in generated. The absolute performance evaluation result is compared with an acceptable achievement level for the particular instructional activity and a next frame selection signal is generated. A next frame is selected for presentation to the student based upon the next frame selection signal.

U.S. Pat. No. 4,997,374 to Simone discloses a teaching device that includes a changeable two channel prerecorded program source, and a console unit including a work booklet. The first channel of the program source includes an audio program comprising a series of spoken words which are audibly reproduced by the console unit and the second channel includes a series of control signals which are operative for actuating lights adjacent prespecified words in the work booklet. The operation of the console unit is coordinated with the audio program so that lights are actuated adjacent to the words in the work booklet as the same words are audibly reproduced by a console unit. One embodiment of the device further includes a plurality of depressible user response buttons on the console unit for indicating responses to questions presented in the audio program.

U.S. Pat. No. 4,781,099 to Koike discloses a musical quiz apparatus that presents a question chord in sound and a trainee answers by depressing the keys of the chord constituting notes on the keyboard. The apparatus is capable of generating a plurality of different chord data respectively representing chords, and generates a question chord datum one at a time more or less randomly selected from among those different chord data and produces sounds of notes which constitutes a chord designated by the question chord data. When the answer is correct, points are added up and a next question chord is presented.

U.S. Pat. No. 5,392,682 to McCartney-Hoy discloses a computerized musical keyboard and a method for using same to play or to learn to play a piano. The computerized musical keyboard includes a piano keyboard connected to a computer. The computer is programmed to select from a music module a piece of music to be played on the piano and to generate a signal indicating the proper keys to be played, the correct sequence in which the keys are to be played, and the hand and finger to be used in striking each key, in order to play on the piano the piece of music selected.

U.S. Pat. No. 5,107,743 to Decker discloses a piano teaching aid having a panel designed to fit over the keys on an existing keyboard so that lights mounted on a panel having more than one color or shape may be located directly above the piano keys to be played. The lights have more than one color or shape in order to distinguish the hand which the user will use to play the piano. The panel also includes a finder window which displays an alphanumeric code which corresponds to a like code appearing next to the score of music to be played. A foot pedal advancing mechanism is used whereby the user can control the speed which the lights display the keys to be struck, using the Foot Pedal to advance one action. The display also can show the music to be played at a tempo set by the user automatically changing from action to action without using the pedal. The panel articulates so that it may be stretched in one or more places so that it can fit over various dimensions of keyboards without interfering with keys to be played.

U.S. Pat. No. 4,331,062 to Rogers discloses an apparatus for visually displaying music notes on a note display panel mounted on an electronic piano with a support arm. The electronic piano has a keyboard electrically coupled to an electronic circuit operable to produce an audio output in accordance with the depression of one or more keys. The arm is rotatable in a mount attached to the piano for movement about a first upright axis. A first motion limiting unit attached to the mount and arm limits the rotation of the arm about the piano. A second motion limiting unit attached to the panel and this arm limits rotation of the panel about an upright axis relative to the arm. A modified structure has the arm fixed to the piano. The panel has grand staff indicia coordinated with vertically disposed first light mechanisms corresponding to chord note information with a second light mechanism diagonally corresponding to ascending note scale information. A keyboard representation is located below the staff indicia. A third light mechanism associated with the piano key indicia of the keyboard representation is coordinated with the second light mechanism to provide visual information as to the keys depressed on the electronic piano. An electric circuit having on-off switches electrically couples the electronic piano with the first, second, and third lights so that the lights can be selectively operated. The electronic circuit has a switch assembly having a plurality of key signature switches operable to coordinate the first, second, and third lights with the piano keyboard in accordance with the key signature of the music that is played.

U.S. Pat. No. 4,366,741 to Titus discloses an electronic piano having a keyboard and an electronic piano circuit connected to a micro-processor used to control a CRT device to provide a video note display concurrently with the depression of one or more keys. A keyboard representation located adjacent the screen of the CRT device is associated with lights used to indicate the key or keys that are played. Manually operated controls cooperate with the micro-processor to allow the back clearing of the screen one note at a time, remove all the notes, retain all the notes, indicate sharp or flat mode of each note, and indicate the duration that a key is depressed by elongating the note on the screen. A metronome unit is used with the micro-processor to provide a visual beat marker on the screen that sequentially moves across the screen. A movable frame connects the CRT device to the piano.

U.S. Pat. No. 5,864,868 to Contois discloses a computer system and method for controlling a media playing device. The system provides a user interface for allowing a user access to media pieces stored in a media database. The interface is also for controlling a media playing device, like a player piano or movie playing video device, that is coupled to the computer to play the accessed or selected piece of media. In one embodiment there is a computer interface that allows a user to display only music that relates to a selected category, like jazz or classical music. Another embodiment allows the user to direct the media playing device to automatically play selected music pieces that are related to a selected music category. Another embodiment allows a user to direct the media playing device to automatically play selected music pieces that are related to the selected music composer or artist.

U.S. Pat. No. 6,204,441 to Asahi et al. discloses techniques for displaying musical information and particularly for visually displaying musical notes, beats and tempos using personal computers or game devices that run musical software programs. The disclosure teaches the use of different colors and different brightnesses to distinguish certain types of musical notation. It has a display screen which shows both base and treble clefs as well as the keyboard and timing indication.

U.S. Pat. No. 6,388,181 to Moe shows computer graphics animation, used with a live video interactive method for playing keyboard music while the user guides his fingers to the keys targeted by the animation with each key to be struck within one beat of time is designated by a colored “sprite”.

U.S. Pat. No. 6,066,791 to Renard et al. shows a system for instructing the playing of a musical instrument, displaying an image on the display device, and instructing the student to focus on the image while preferably using a musical instrument to play the notes on the staff.

U.S. Pat. No. 5,540,132 to Hale shows techniques for teaching musical notation to children. Each note is associated with the distinctly identifiable color which is then associated with an object which naturally occurs in this color. They utilize cartoon characters which apparently enhances association within the mind of the child.

U.S. Pat. No. 6,337,433 to Nishimoto et al. shows an electronic musical instrument having performance guidance function, performance guidance method, and storage medium storing a program therefore with a plurality of display devices arranged in association with the performance operating elements, respectively, each comprising a pair of display elements corresponding to left and right hands of the player, respectively.

U.S. Pat. No. 6,284,961 to Kimmel, Jr. shows a system of musical notes with the notes being associated with a color and utilizes stickers for application to the keys of the musical instrument to correspond to the colors of the note which it plays.

Each of these prior art references disclose improvements in the area of interactive musical instruction. However, none of the foregoing instruction aids have adequately addressed the inherent challenges of learning musical notation, or of providing an alternative means of tabulature or notation for learning music and songs that adequately conveys the parameters of pitch and rhythm.

Examples of prior patents in the general area of game pad controllers are outlined below, wherein wach of the following references are herein incorporated by reference for their supporting teachings.

U.S. Pat. No. 5,923,317 to Sayler et al. Shows a two-handed game controller which has a single dual analog/digital x-y directional pad mounted on the top which can perform either analog or digital functions. A mode switch on the controller allows an operator to select either analog or digital control settings. The controller also has a button grouping located within a concave recess. Each button within the recess has a downward slanting top maintained at an elevation a specified distance from the controller, thereby allowing for easy actuation by a gliding, rolling or sliding motion of a user's thumb or finger. The controller also has semicircular sides and 3-dimensionally tapered hand-grips, facilitating grip from virtually any size hand, from child to adult. Digital triggers are mounted on both the top and bottom of the controller and are configured to perform the same functions, allowing table-top use.

U.S. Pat. No. 5,759,100 to Nakanishi shows a game machine controller with a memory pack equipped with a nonvolatile memory. The memory pack is able to store a plurality of commands designated by a predetermined button operation as command programs. Once the data is stored, it is retained unless it is compulsorily rewritten or deleted. The command program stored in the memory pack is retrieved and executed by a simple operation of the command buttons. The memory pack can be attached and detached freely so that it can conform to each software. As a result, once the command programs are stored, there is no need to renew the command programs every time the game software is replaced.

U.S. Pat. No. 5,551,693 to Goto et al. shows a controller unit for controlling an electronic device such as a video game. The controller unit comprises a housing with a pair of handles diverging toward a user and gripped by the palms of the user, first and second control sections arranged on the top of the housing and each including a plurality of key elements, and third and fourth control sections arranged on the front side of the housing and each including upper and lower key elements. The first control section comprises a key body having a first semispherical recess on its bottom and a second semispherical recess on its top, a spherical fulcrum member located below the key body and engageable with the first recess, a base plate mounted in the housing and including fixed contacts, a resilient body disposed between the key body and the base plate and including movable contacts, and a key support centrally located at the key body and having a semispherical projection engageable with the second recess.

Finally, U.S. Pat. No. 5,394,168 to Smith et al. shows a hand-held controller for an electronic gaming system wherein each of one or more players can control two gaming objects at the same time. A joystick-like thumb operated directional switch, mounted in a housing, is used to select or control the movement of a primary object and an optical detection/pointing system, carried in the same housing, is used to select or control the movement a secondary object.

### SUMMARY OF THE INVENTION

The invention is related to an input gamepad device and a process for interpreting MIDI files into a computer video game, which can be generated with software for a personal computer, personal digital assistant device or with the Input gamepad device that interfaces directly with a TV monitor or is a standalone device with built in monitor and speakers. The object is to strike the appropriate kalimba tongue on the attached input gamepad device as the game object touches the graphic representing the correct note on the virtual piano keyboard.

MIDI files storing musical notation and other information are used to generate unique game fields and objects, whereby game objects stream upward or downward toward a virtual piano or graphic representing it. If streaming upwards, then game objects and field of play then can morph into a musical staff turned vertically (90 degrees clockwise) to put the pitch axis parallel with piano keyboard layout with moving musical notation. The target virtual piano and direction of streaming game objects are thus parallel to the player's Input gamepad device, allowing easy correlation with the correct key.

The game interface can later gradually and/or progressively rotate counter-clockwise 90 degrees and morph into moving standard musical notation. Game objects are spaced proportionate to the melodic, and rhythmic structure to facilitate interpretation of relative timing in game play, and move toward virtual piano in tempo of music, allowing visual and audio anticipation and precise rhythmic play by user. Graphics of the virtual piano, the game objects and the Input gamepad device keys can be color coordinated. The game keeps track of hits and misses, generating a score and a musical map for review, and allows game objects to be numbered for fingering clues.

In one embodiment, in the beginning phases of the game, the player will see game objects, representing notes of a song, rising from near the bottom of the screen toward the virtual piano keyboard, and their vertical relationship to each other shall be a representation of relative musical time. As these game objects approach the virtual piano keyboard, the corresponding piano key along that path is visually obvious, and the objective of the player is to hit the corresponding key on the respective kalimba tongue at precisely the time the game object is located within a predefined hit window vis a vis the virtual keyboard. If the player strikes the correct tongue at the correct time, audio and visual feedback will reward the player.

The player's main task in the invention is to hit the corresponding kalimba tongue for as many of the moving objects as possible at the right time, repeating the challenge until they have reached a certain percentage of correctness and move up to the next level of complexity. In doing so, players may subconsciously learn to play a song and to eventually recognize and read sheet music.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

The objects, features and advantages of the system of the present invention will be apparent from the following description in which:

FIG. 1 shows an embodiment of the gamepad device that attaches to the game machine, personal computer, personal digital assistant, personal game, or a similar device.

FIG. 2 shows an embodiment of the gamepad device that exists as a stand-alone unit. The display device and software are incorporated into the gamepad device, so it can act as a stand alone portable unit.

FIG. 3 shows an embodiment of graphical user interface (hereinafter “GUI”) at first position, according to the present invention.

FIG. 4 shows the GUI of FIG. 3 as it is rotating into second position.

FIG. 5 shows the GUI of FIG. 3 in second position

FIG. 6 shows the transformation of the game object trajectories into staff lines and spaces.

FIG. 7 shows a variation in the starting layout of the GUI.

FIG. 8 shows an embodiment of the present invention utilizing variations in the game objects.

FIG. 9 shows yet another embodiment wherein utilizing variations in the game objects.

FIG. 10 shows a block diagram of exemplary hardware and software modules for carrying out the invention.

FIG. 11 shows the format of a MIDI file.

FIG. 12 shows the format of a header chunk of a MIDI file.

FIG. 13 shows the format of a track chunk of a MIDI file.

FIG. 14 shows the format of META events from a MIDI file.

FIG. 15 shows an example of a portion of a MTrk chunk of MIDI data together with exemplary semantics.

FIG. 16 shows an exemplary flow of data illustrating MIDI messages for the sequential playing of three notes.

FIG. 17 shows a flow chart of an exemplary process for interpreting the MIDI data stream of FIG. 5 for generating game objects for display.

FIG. 18 shows a block diagram showing an exemplary arrangement of game modules in accordance with one aspect of the invention.

FIG. 19 shows a block diagram of an exemplary computer that can be used to implement various aspects of the invention.

### DETAILED DESCRIPTION OF THE INVENTION

The presently preferred embodiments of the invention will be best understood by reference to the drawings, wherein like parts are designated with like numerals throughout.

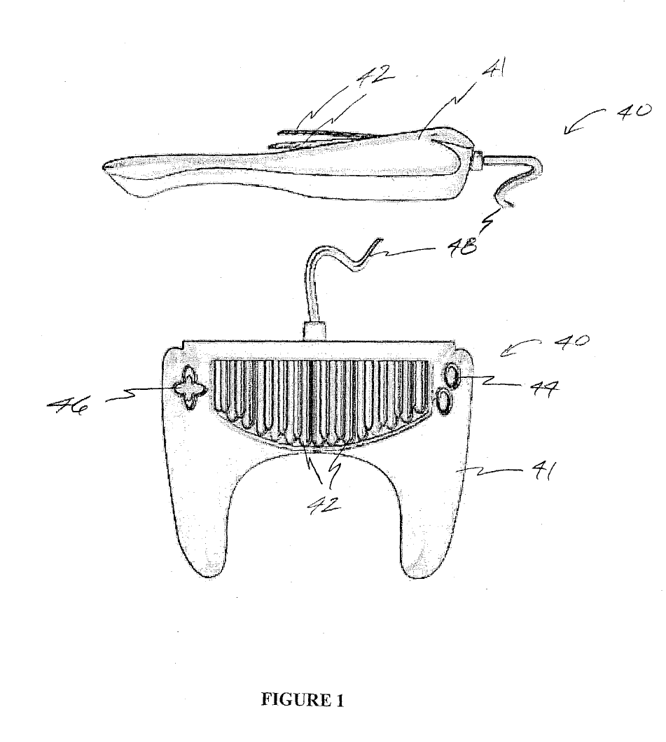

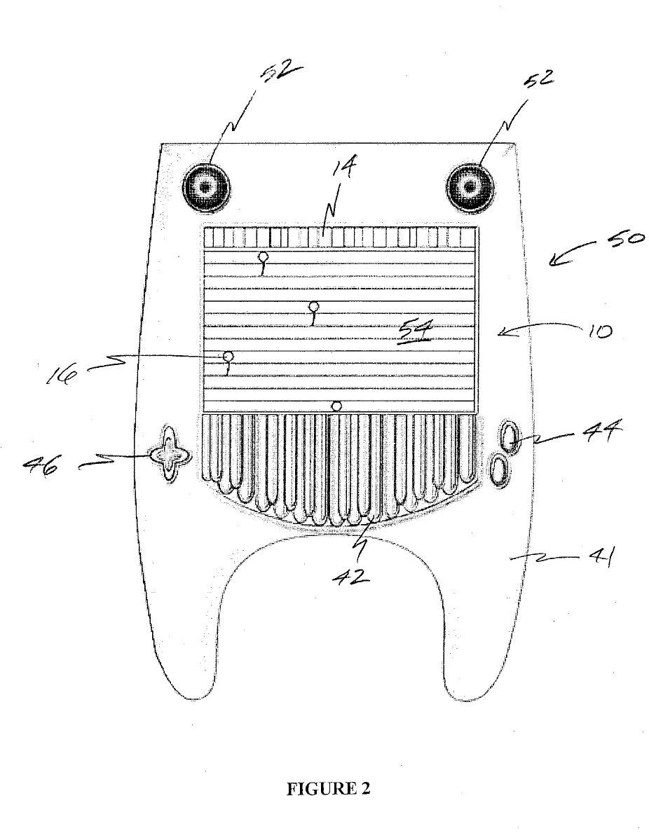

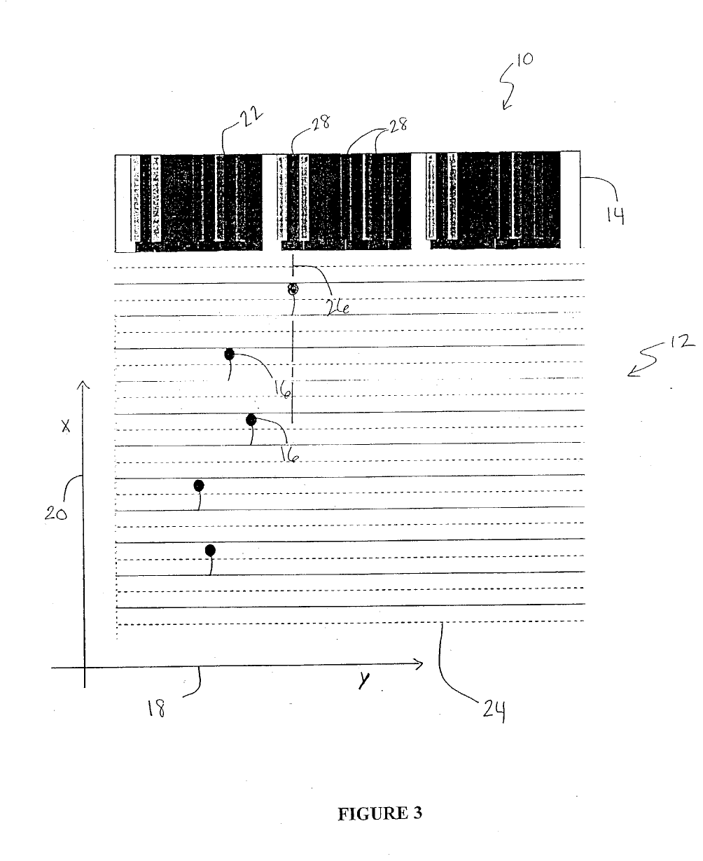

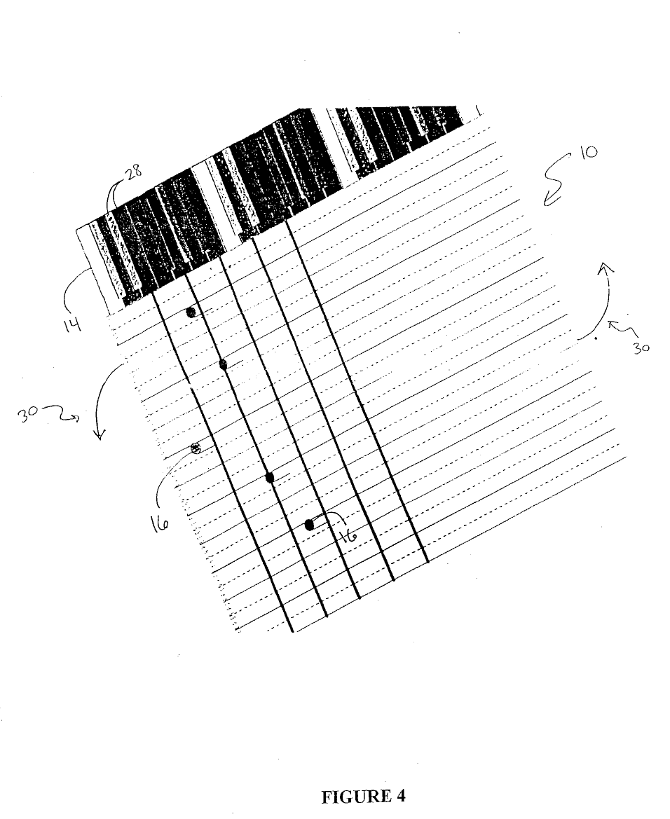

The present invention provides an interactive game that allows a more logical transition to learning musical notation and songs. Specifically, the present invention involves a process for interpreting MIDI files into a computer video game which can be generated with software for a personal computer, a personal digital assistant, or with a hardware component that interfaces directly with a TV and the gamepad device (see 40 at FIG. 1), or a standalone gamepad (see 50 at FIG. 2) with a built-in LCD monitor (see 54 at FIG. 2) and speakers (see 52 at FIG. 2). MIDI files storing musical notation and other information are used to generate unique game fields and objects on a GUI whereby, game objects (see 16 at FIG. 4) stream upward toward a virtual piano keyboard (see 14 at FIG. 3). The game objects (16) later gradually convert to vertical moving musical notation (a musical staff turned 90 degrees clockwise to put pitch axis parallel with piano) (see 16 at FIG. 4). In this way, in the initial phases of the game, the target virtual piano keyboard (14) and streaming graphic game objects (16), which represent musical notes, are parallel to the player's input gamepad device (see 40 at FIG. 1), allowing easy correlation with the correct kalimba tongue (see 42 at FIG. 1).

The game interface (see 10 at FIG. 3) may later rotate counter-clockwise between zero (0) and ninety (90) degrees, and morph into horizontally moving classical musical notation. Game objects (16) are spaced proportionate to the melodic, harmonic and especially rhythmic structure to facilitate interpretation of relative rhythmic timing in game play. Game objects (16) move toward the virtual piano keyboard (14) in tempo of music, allowing visual and audio anticipation and precise rhythmic play by user. The virtual piano keyboard (14), the game objects (16) and the input gamepad device (40) keys can be color coordinated to facilitate correlation of correct note with correct piano key. The game may keep track of hits and misses, generate a score and a scrollable musical map for review, and allow game objects (16) to be numbered for fingering clues.

Referring now to FIG. 1, the gamepad device (40) is used to connect to a video game console, a personal computer, a personal digital assistant, or integrated into a stand alone unit with a self-contained monitor and CPU. It is roughly modeled after the thumb piano or kalimba, with the following important differences:

A) The tongues (42) are electronically linked, conveying precisely timed information to the game unit or software, including, in one embodiment, velocity for dynamic variations;

B) The tongues (42) are color coordinated to the game objects (16) and integrate with the virtual piano keyboard (14) and game;

C) The tongues (42) are spring loaded to be able to return to position rapidly for subsequent note playing; and

D) The tongues (42) are programmable for multiple types of tuning.

Addition, FIG. 1 illustrates a cord (48) for connecting the gamepad (40) to a personal computer, a personal digital assistant, etc. Right-hand controls (44) and left-hand controls (46) are embedded within a housing (41) containing the tongues (42), the cord (48), and the controls (44, 46).

Referring now to FIG. 2, a stand-alone gamepad (50) is shown with a GUI (10) displayed on an LCD screen (54). The GUI depicts the virtual piano keyboard (14) and game objects (16) moving along predetermined paths. The stand-alone gamepad (50) includes speakers (52) embedded within the housing (41).

Referring now to FIG. 3, a GUI (10) is shown according to the present invention. In the game, there are several possible views of the GUI (10). The default should be a'straight overview of the rectangular grid-based playing field (12), with the virtual piano (14) at the top of the screen, or interface (10), and the game objects (16), which represent notes, moving upward.

The underlying GUI logic will be that of objects (16) moving upward or downward along an invisible graph-paper like grid with the horizontal y-axis (18) representing the pitch (left=lower pitch, right=higher pitch) and the vertical x-axis (20) representing time (up=beginning of piece, down=end of piece) as subdivided by eighth notes or triplets or sixteenths, whichever is musically appropriate.

Along the top (22) of the screen or interface (10), or perhaps ¾s of the way up from the bottom (24), with space above and below will be a virtual piano keyboard (14) stretching horizontally across the screen. The grid panes (shown in broken lines at 26) along the horizontal y-axis (18) will exactly correspond one for one to each key (28) on the virtual keyboard (14).

The GUI (10) of the present invention is thus a unique variation on the piano roll interface seen on some MIDI sequencer devices, which is, in turn, a variation on player piano rolls and music box construction.

Some key differences between the present interface (10) and current piano roll interfaces are as follows. First, the interface (10) of the present invention is turned 90 degrees, thus reading and moving from bottom (24) to top (22) instead of left to right to facilitate intuitive hand eye coordination, resulting in a moving interactive piano tablature.

The present invention provides an interactive game that allows a more logical transition to learning musical notation. Specifically, the game simplifies musical notation into a grid of x and y, but with pitch moving from left (lower notes) to right (higher notes), parallel with the virtual piano keyboard (14) layout, and the dimension of time moving up from down (the bottom of the screen being the end of the piece). Thus the game is played with two “instruments”, one target virtual piano keyboard (14) on the GUI, the other being a kalimba shaped gamepad (40) that plugs into a gameport, and is positioned in front of a TV or monitor, and is used with the game.

At the beginning stages of the game, the virtual piano keyboard (14) is on the top (22) of the screen (10). The notation is turned ninety (90) degrees clockwise, and disguised as chromatically spaced graphic game objects (16) moving upwards in a parallel stream toward the virtual piano keyboard (14). By turning the underlying musical grid of pitch and time clockwise 90 degrees, the target virtual piano keyboard (14) is also parallel with the user's gamepad (40).

In the beginning phases of the game, the player will see blocks or objects (16) rising from the bottom (24) of the screen (10) toward the virtual piano keyboard (14), and their vertical and horizontal relationships to each other shall be a representation of relative musical time and pitch. As these objects approach the virtual piano keyboard (14), the corresponding kalimba tongue (42) along that path will be visually obvious, and the object of the player is to hit the corresponding tongue (42) at precisely the time the block (16) touches the key (28) on the virtual piano keyboard (14). The game objects (16), the virtual piano keyboard (14) and the gamepad tongues (42) can be color coded with stickers or by design from the manufacturer. Thus, this game design combines these graphic and feedback elements to create a completely new, efficient and fun means of teaching a user to play the kalimba and to read musical notation.

More specifically, the game objects (16) may be spaced proportionally to the rhythm and pitch of the song to facilitate interpretation of relative timing in game play. The game objects (16) may move smoothly toward the virtual piano keyboard (14) or in tempo with the music, allowing visual and audio anticipation of the correct rhythmic timing to enable precise game play.

It is noted that the dimension of time, which carries rhythmic information, flows graphically UPWARD, toward the virtual keyboard (14) or graphic representing it positioned toward the top (22) of the screen or monitor. This upward flow of game objects (16) relative to the virtual piano (14) allows the game to gradually return to classical musical notation without losing coherency for the user. The game can also be use with the game objects flowing downward, but this eliminates the possibility of a logical transition to musical notation.

It is also noted that the game objects (16), virtual keyboard (14) and tongues (42) can be color coded to facilitate easy correlation with each other. The interactive game can provide instant visual and/or audio feedback to let players know how they are doing. The game can also keep a detailed tally of score, hits and misses, providing an editable map of the game field for later review.

Referring now to FIG. 4, there is shown a gradual counter-clockwise rotation (shown at 30) of the interface (10). This rotation may occur at advanced stages and levels of the game. Thus, as play progresses, the playing field gradually converts to traditional musical notation. As the playing field (12) converts to traditional musical notation, the underlying musical map of musical notation becomes apparent.

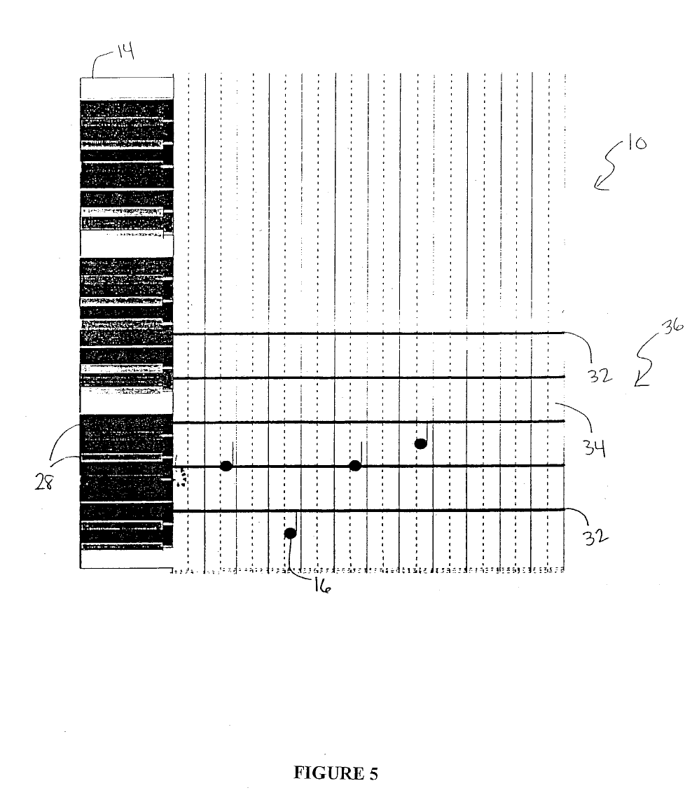

Referring now to FIG. 5, the interface or screen (10) is illustrated as transforming from a grid to a musical staff (36). The trajectories along the grid panes (26) transform into staff lines (32) and corresponding spaces (34). In this manner, the interface (10) eventually assumes the traditional left to right reading view of standard musical notation. It is noted that at this stage of the game, the game objects or notes (16) can still be colored and the virtual target keyboard (14) still in view. However, as is apparent, the virtual piano keyboard (14) orientation is now vertical.

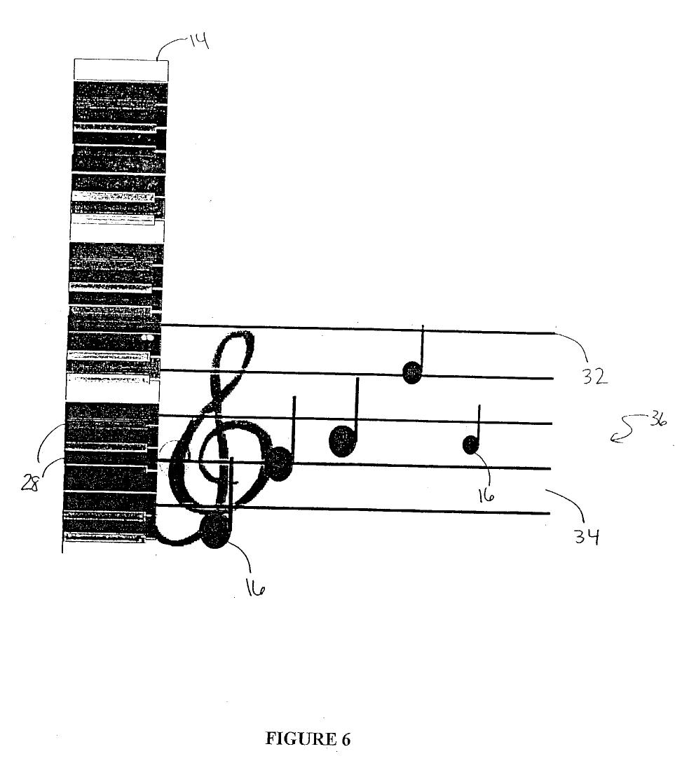

Referring now to FIG. 6, the game objects, or notes (16), and the view are going from colored to black, but they are still moving toward the virtual piano keyboard (14), and gradually the other elements of traditional musical notation enter the game. This is represents the highest playing levels of the game. By now, the player can play the song almost perfectly, and at these levels is conditioning him or herself to recognize the underlying logic of musical notation.

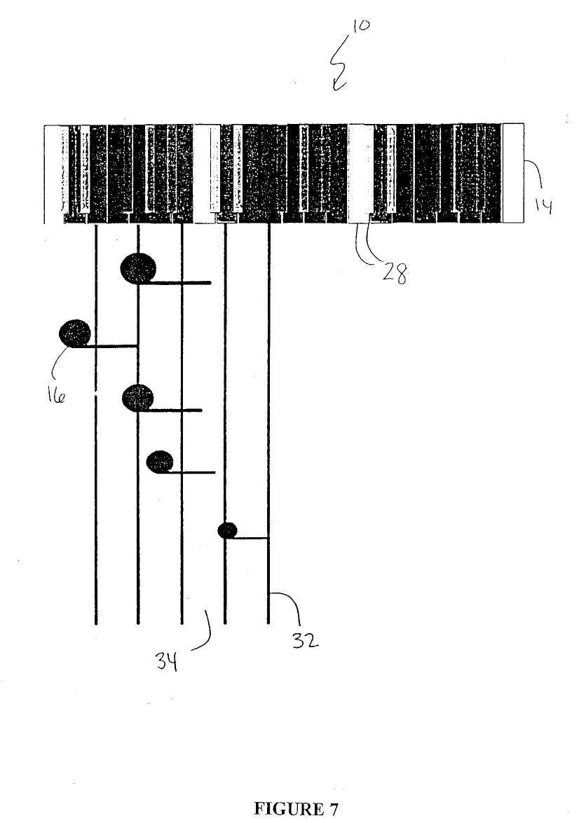

Referring now to FIG. 7, a variation in the starting layout is shown. In this embodiment, the player's view starts with a vertical musical staff (rather than horizontal) according to the player's wishes. In fact the vertical staff coupled with moving notes is a new form of musical notation, and piano tablature.

Referring now to FIG. 8, an embodiment is shown wherein the game objects are caterpillars turning into butterflies, rather than balloons.

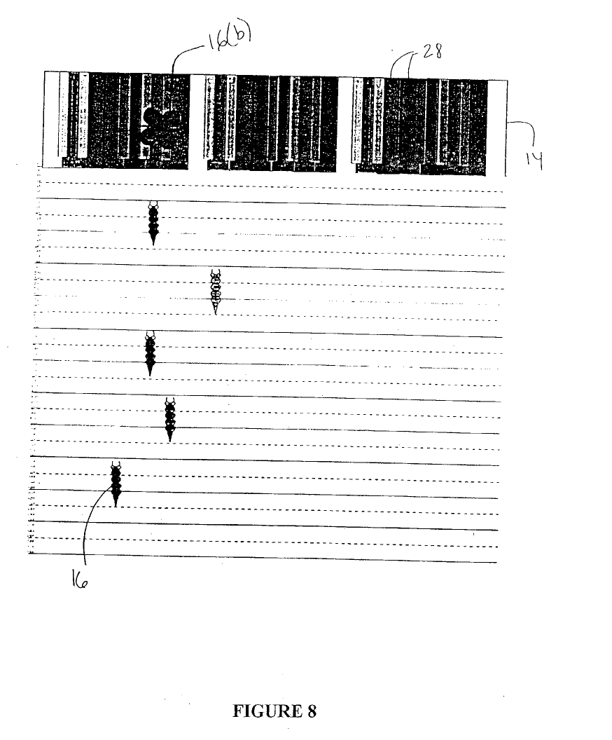

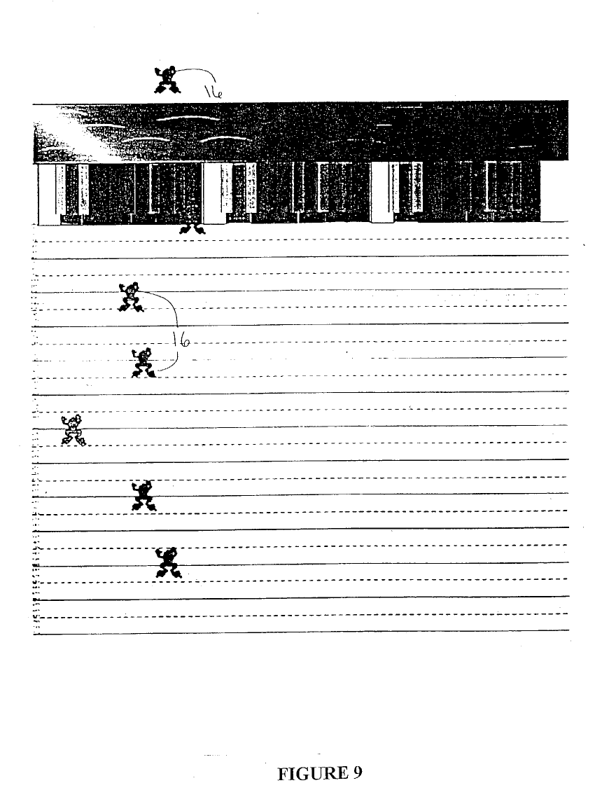

Referring now to FIG. 9, there is similarly shown a variation of the game objects. In this embodiment, the game objects are hopping frogs.

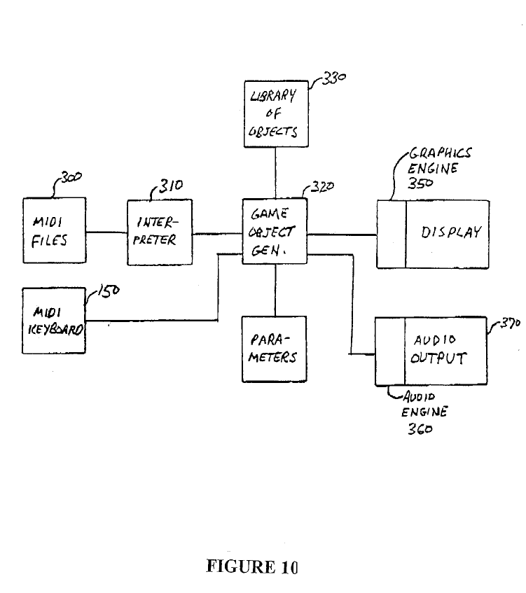

Referring now to FIG. 10, a block diagram of exemplary hardware and software modules for carrying out various aspects of the invention is shown. Although this particular embodiment of the invention is described with respect to the use of MIDI files and music formatted in accordance with a MIDI standard, other formats for music are well known and can be utilized in alternative embodiments of the invention.

In this exemplary embodiment, one or more files (300) formatted in a MIDI format are stored in, for example, a library, or downloaded in real time and fed to interpreter (310) where the MIDI data file is interpreted and translated in to commands which drive the game object generation module (320) which causes the display of game objects on the GUI on the display screen and provides audio output (370) to the speakers of a computer. Conveniently, a graphics engine (350) and an audio engine (360) simplify the translation of game objects into audio and visual components driving the visual display and the audio output. The game object generator has access to a library of objects (330) and to a set of game control parameters 340. Each of these modules are described in more detail hereinafter.

Also shown in FIG. 10 is a set of parameters (340) which allow a user to customize the performance of the game or the behavior of the game in certain instances. The audio engine (360) is preferably based on Microsoft® DirectSound 8 application programming interface. The audio engine generally has the ability to play short .WAV files through the PCM channels of a sound card. The sound engine is implemented as a class with constructors, destructors, loading of a .WAV file and playing of a .WAV file. The sound engine is used primarily for playing sound effects associated with menu buttons, clicks, switches and game play feedback sounds. However, the invention could also work with other software engines.

The graphics engine (350) works in conjunction with the library of objects (330) and the game object generation module (320) to produce graphical objects on the screen that constitute respective implementations of the game objects utilized to play the game. The invention is capable of loading and playing three types of song files: MIDI, MIDI Karaoke, and .amm. The later is an internal song format described more hereinafter. Standard MIDI files were described above. The MIDI Karaoke file is essentially a standard MIDI file with song lyrics built into one of the tracks according to a certain format. The invention supports the .KAR file format which is a prevailing file format in the shareware/public domain markets.

An .amm file is very similar in structure to a standard type 1 MIDI file. However, the .amm format file will also hold annotations, highlighting and fingerings. Annotations are simple text notes that are stored on a song's timeline. These annotations can hold valuable information to a user and can be displayed during the game play along with other scrolling game objects. They may be stored as text in the internal file, but on the screen these are shown in the form as speech balloons with or without arrows pointing to other game objects.

Some notes in an .amm file can be highlighted. This is essentially a flag that tells the system that a note should be displayed with an enhanced video effect such as a halo effect around it. Fingerings are little clues to a user as to which finger should be used to play a note on a piano keyboard. Fingerings are assigned to individual notes and hold a number in a range from 1 to 5. During game play, game objects that have fingerings assigned will scroll along with the number placed on them.

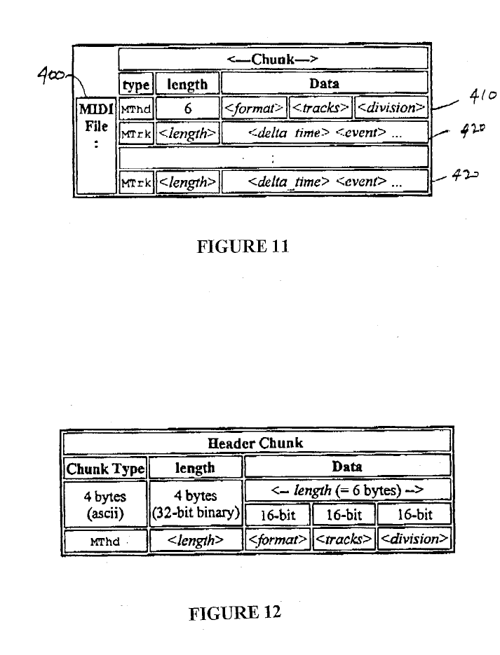

Referring now to FIG. 11, the format of a MIDI file is illustrated. As noted above, the MIDI file format is utilized for purposes of illustrating the invention, but the invention is not limited hereto. An example of another file suitable for carrying out the invention would be that of an MPEG-4.

MIDI files are structured into chunks. Each chunk consists of a 4-byte chunk type, a 4-byte indication of length indicating of the length of the bytes contained in the data field. There are two types of chunks, namely header chunks (which have a chunk type of “MThd” (410)) and track chunks which have a chunk type of “MTrk” (420). A MIDI file consists of a single header chunk followed by one or more track chunks.

Referring now to FIG. 12, the format of a header chunk of a MIDI file is illustrated. The header chunk comprises three fields, namely, chunk type, length and data. For a header chunk, the chunk type is MThd. The length field contains the length in bytes of the chunk data part. The “format” portion of the data field includes the MIDI file format which can be only formats 0, 1 and 2. The “tracks” portion of the data field as a binary number indicating the number of track chunks contained in the MIDI file. The “division” portion of the data field of the header chunk defines the default unit of “delta-time” for the MIDI file. If the most significant bit of the “division” field is a 0, the remaining 15 bits indicate the number of “ticks per quarter note” to be utilized in representing and reproducing the music. If the most significant bit is a logical 1, then there are two components indicated by the remaining 15 bits. Bits 8-14 would indicate the number of frames per second (indicated as a negative number) and the least significant 8 bits represents the number of ticks per SMTPE frame.

MIDI files come in three variations. Format 0 contains a single track. Format 1 contains one or more tracks which are all played simultaneously. Format 2 contains one or more independent tracks which can be or are played independently of the others.

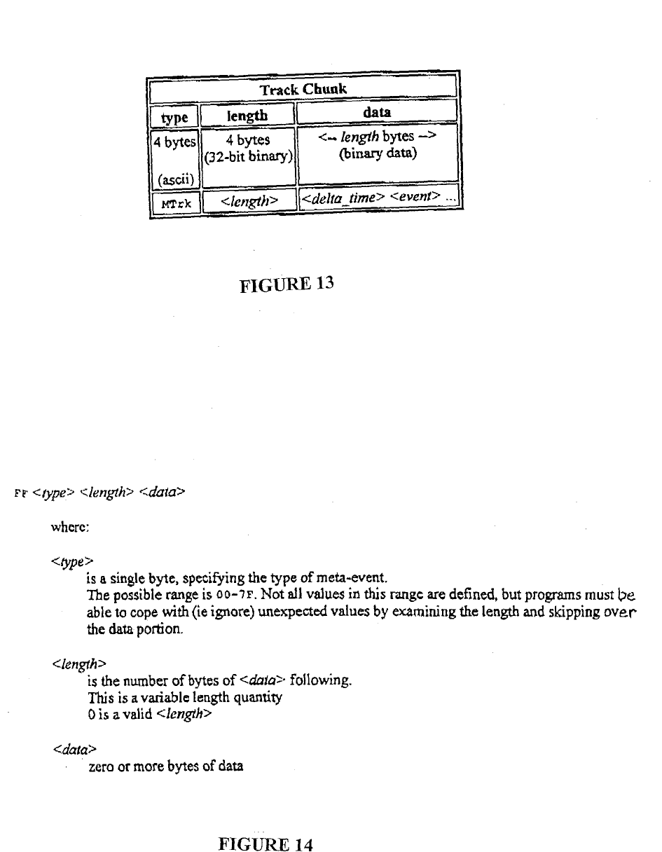

Referring now to FIG. 13, the format of a track chunk of a MIDI file is illustrated. It comprises a chunk type which, by definition is a MTrk type and a length field which indicates the length of the data portion in the track chunk. The data portion of a track chunk comprises two elements,. The first is a “delta_time” portion and “event” portion. delta time is the number of “ticks” from the previous event and is represented as a variable length quantity. There are three types of events that are defined within the standard. They are a “MIDI event”, a “SYSEX event” and a “META event”. There are no explicit delimiters between the “delta_time” and “event” instances. This is possible because both fields have clearly defined lengths.

A MIDI event has any MIDI channel message. These include channel voice messages and channel mode messages. Messages other than MIDI channel messages to be included in a MIDI file can utilize the SYSEX event. Most system exclusive messages are quite simple and are sent as a single 6. packet of bytes, starting with F0 and ending with F7. However, some system exclusive messages are used to control device parameters in real time. Two different types of SYSEX events are defined to accommodate the different usages. META events are used for things like track-names, lyrics and que points, which don't result in MIDI messages being sent, but are still useful components of a MIDI file.

Referring now to FIG. 14, a MIDI events form is illustrated. MIDI events are preceded with the hexadecimal notation FF followed by a type field, a length field and a data field. The type field is a single byte specifying a type of META event. The length field contains a number of bytes of data following that field. The data field includes 0 or more bytes of data. A number of META events have been defined in the standard that make implementation of the invention easier. These include the following:

A) A “sequence number” is an optional event which must occur only at the start of a track before any non-0 delta_time. This is typically utilized to identify each track.

B) A text event is utilized for annotating a track with arbitrary text.

C) A Copyright notice event can be utilized where a Copyright notice is represented in ACSI text. It should be the first event on the first track of a MIDI file.

D) A sequence/track name provides the name of a sequence or a track in the file.

E) An instrument name, provides the description of the instruments used on the track.

F) A lyric event provides the lyrics for a song. Normally, each syllable will have its own lyric-event, which occurs at the time the lyric is to be sung.

G) A marker event marks the significant point in the sequence such as the beginning of a verse.

H) A que point is utilized to include queues for events happening on-stage, such as “curtain rises”, “exit”, and the like.

I) An end of track event must be utilized to give the track a clearly defined length. This is essential if the track is looped or concatenated with another track.

J) A set tempo event sets the tempo in microseconds per quarter note. This means a change in the unit-length of the delta_time tick. The default tempo is a 120 beats per minute.

K) A SMTPE offset event specifies the SMTPE time at which the track is to start.

L) A time signature representing the standard time signature for a piece of music, such as 3/4 or 6/8 or 2/2.

M) A key signature event can specify the number of sharps or flats and a major or minor flag.

N) A sequence-specific META event allows a manufacture to incorporate sequencer specific directives into a MIDI file.

Thus FIG. 7 illustrates the format of META events from a MIDI file.

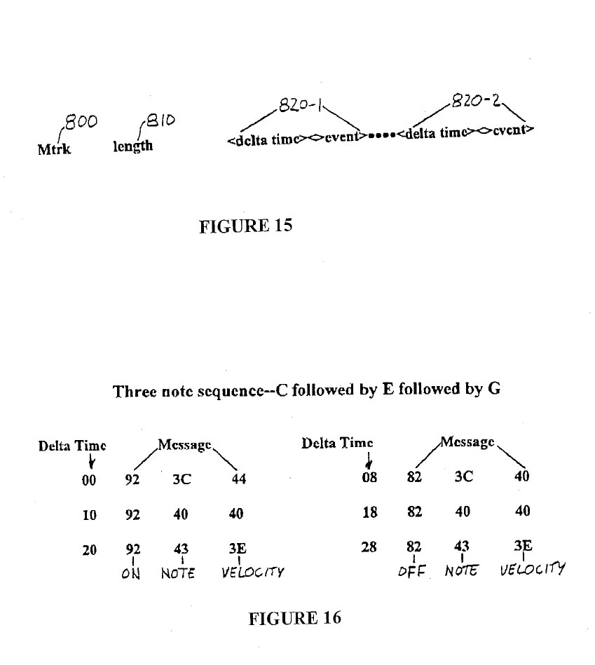

Referring now to FIG. 15, there is shown an example of a portion of an MTrk chunk of MIDI data together with exemplary semantics. As shown in FIG. 15, an MTrk chunk is introduced with an MTrk identifier (800) followed by a length field (810). The plurality of ordered pairs of delta_time and event fields (820-l through 820j) then follow which represent the individual MIDI messages associated with the MTrk chunk.

The MIDI protocol consists of messages which are designed to allow synthesizers and sequencers to communicate what-sound-to-play information. A typical MIDI message comprises three components. The first component begins with a hexadecimal 9 is followed by an identification of one of sixteen MDI channels having a value of 0-F. The second component is a two byte sequence representing the key on the device that has been pressed. This corresponds to the notes of a keyboard that has been pressed in the case of a piano-type keyboard. The two byte value ranges from 00-7F. The third component of a MIDI message is the velocity component which specifies the velocity with which the key was pressed or released. It, too, ranges in value between 00 and 7F. Thus, if a musician pressed middle-C key on a keyboard, the keyboard would send a “note-on” message comprising: 90 3C 40. When the musician releases the key, the corresponding “note-off” message would comprise: 80 3C 33. In this case, the key was released more slowly than it was pressed as indicated by the velocity indication 33 in the release message (compared with the attack velocity 40). Other MIDI messages may include a program (instrument) change, a pitch blend message, a control change message (e.g. pedal/switch foot change of state) and timing clock message.

MIDI messages are all one way. There are no acknowledgement messages sent from the receiver back to the transmitter. If a MIDI device does not know what to do with a message, it will ignore it. MIDI messages which are specific to a MIDI channel are referred to as channel messages. MIDI messages which affect the entire MIDI system or an entire MIDI device are known as system messages. Channel and system messages are further divided into several classes. The channel voice messages are messages which start, alter or stop a sound or sounds being played. Channel mode messages effect the entire channel. System realtime messages are those used by sequencers to regulate and synchronize timing. They do not contain data bytes. System common messages include messages such as song position pointer, song select and the like. System exclusive messages are generally used for device specific extensions to a MIDI protocol.

Since MIDI messages are sent and interpreted in realtime, it is desirable to reduce the volume of data that must be sent. For ordinary note-on and note-off messages, it is quite common for several notes to be turned off and on more or less at the same time. In such cases, it is possible to send a single status command, such as note-on followed by a plurality of “note identifier, velocity” pairs without repeating the same status byte for each note that is turned on or off. This reduction in the transmission of status bytes is known as “running status” within MIDI messages. Only the data bytes that change are sent.

Against the background of the MIDI File and protocol, an exemplary operation of that invention will now be described.

Referring now to FIG. 16, there is illustrated an exemplary flow of data illustrating MIDI messages for the sequential playing of three notes. Two MIDI messages are shown per line. Each is introduced with a delta_time field. Thus, the six messages shown in FIG. 16 are preceded with delta_time increments of 00, 08, 10, 18, 20 and 28.

The delta_time increments are followed by a MIDI command sequence. The sequence 92 indicates the situation where a note is to be turned on. Following each 92 message is a message with a command field of 82 which indicates that the note is to be turned off. Following each command is a note identifier. Which in the case of the first line indicates the note C is to be turned on and off. In the case of the second and third lines, the notes identified are the note E and the note G, respectively. The last component of each message is a velocity component. In the first line, the velocity 44 is a measure of how fast the key is pressed downwardly (e.g. attack velocity). In the following message, where the key is being released, the velocity 40 indicates that the key is released with a velocity 40.

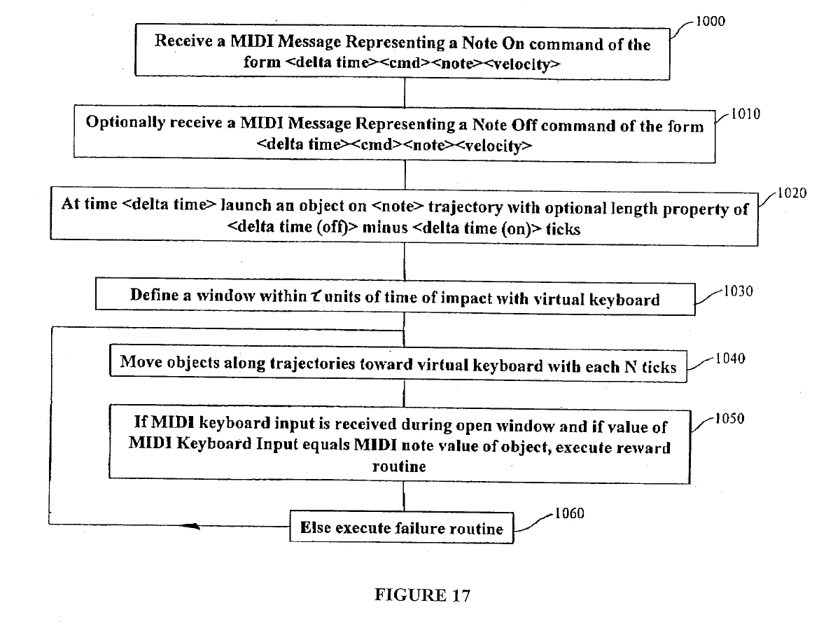

Referring now to FIG. 17, a flow chart of an exemplary process for interpreting the MIDI data stream of FIG. 12 is shown, as part of generating game objects. When a MIDI message is received representing a note on object of the form <delta_time> <Command> <Note> <Velocity> (1000) optionally followed by a MIDI message representing a note-off property of similar format (1010). At time <delta_time> less traversal time, an object is launched on <Note> trajectory with optional length property of <delta_time (off)>−<delta_time (on)> ticks (1020). In this form, one can see that steps 1000-1020 represent an interpretation of the incoming MIDI messages followed by the generation of a game object. Messages are received and interpreted on an ongoing basis in accordance with the steps 1000-1020. A window is defined within X units of time of impact with the virtual keyboard (1030).

Once the object is launched on the note trajectory, the object is moved along the trajectory towards the virtual keyboard with each N ticks of the MIDI clock (1040). If MIDI keyboard input is received during an open window and if the value of the MIDI keyboard input equals the MIDI note value of the object about to impact the virtual keyboard, video and audio reward presentation (routines) are activated (1060). Otherwise, a video and audio sequence representing a failure can be activated. This process is repeated for each tick of the MIDI clock in an iterative fashion as indicated by the arrow going back to the top of step 1040.

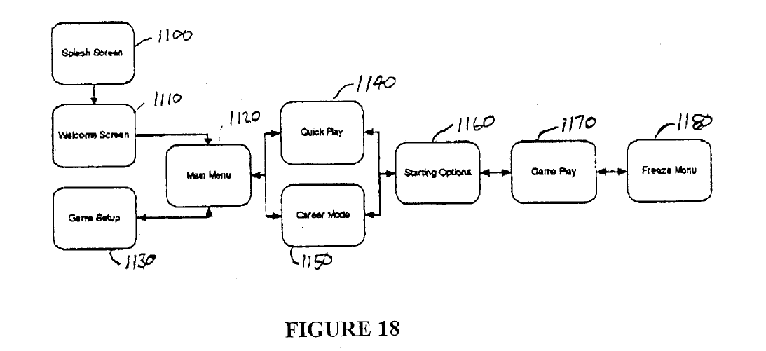

Referring now to FIG. 18, a block diagram showing an exemplary arrangement of game modules in accordance with one aspect of the invention is illustrated. When a game is first loaded, a splash screen (1100) is displayed. This is centered on the desktop and enables the user to click on icons or links that would take them to the sponsoring company's website where they can download new songs for the game. Also, there may be a link to HTML documentation for the game.

The Welcome Screen (1110) allows four options. First, it allows selection of a main menu which is described hereinafter. Second, it allows access to an instant play mode of operation, described in conjunction with item (1140) hereinafter, which assumes all previously set up configurations of the last song played in the game. A third option from the main menu takes one to the credits screen where game credits are revealed in a visual way. Finally, the main menu (1120) has an option to exit the game and return to the operating system.

From the main menu (1120), there are three options. If a quick play option is selected, the user goes directly to the quick play mode described in conjunction with (1140) where the user can freely load any song, select a number of options and commence the practice. No profile needs to be selected or created. In the second main menu option, the career mode, a user will create a profile and will face a number of challenges, predefined within a number of levels and in a number of different kalimba playing methods. These are discussed in detail hereinafter in conjunction with career mode (1150).

Also from the main menu, a game set up (1130) may be selected. In game set up, a number of game objects can be configured as described more hereinafter. Instant play (1140) allows the user to play the game without the hassle of going through start up options. While previous starting option parameters are assumed, including the last song played if the game was initially installed and no songs have been played yet, a default song is assumed. Instant play has no menu, it is just a short cut to the game play.

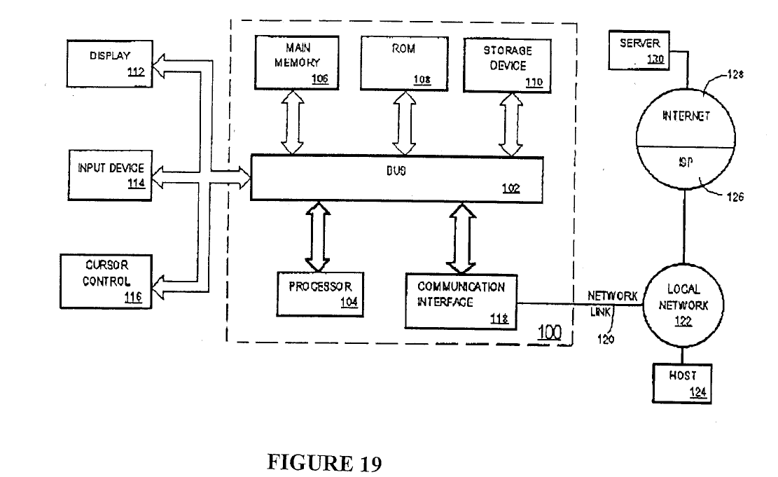

Referring now to FIG. 19, a block diagram showing details of an exemplary computer that can be used to implement various aspects of the invention is illustrated. The description of the invention which follows is exemplary. However, it should be clearly understood that the present invention may be practiced without the specific details described herein. Well known structures and devices are shown in block diagram form in order to avoid unnecessarily obscuring the present invention. At least portions of the invention are intended to be implemented on or over a network such as the Internet. An example of such a network is also described in FIG. 19.

A computer system (100) is illustrated, upon which an embodiment of the invention may be implemented. The computer system (100) includes a bus (102) or other communication mechanism for communicating information, and a processor (104) coupled with the bus (102) for processing information. The computer system (100) also includes a main memory (106), such as a random access memory (RAM) or other dynamic storage device, coupled to the bus (102) for storing information and instructions to be executed by the processor (104). The main memory (106) also may be used for storing temporary variables or other intermediate information during execution of instructions to be executed by processor (104). Computer system (100) further includes a read only memory (ROM) (108) or other static storage device coupled to the bus (102) for storing static information and instructions for the processor (104). A storage device (110), such as a magnetic disk or optical disk, is provided and coupled to the bus (102) for storing information and instructions.

The computer system (100) may be coupled via the bus (102) to a display (112), such as a cathode ray tube (CRT), for displaying information to a computer user. An input device (114), including, for example, alphanumeric and other keys, is coupled to the bus (102) for communicating information and command selections to the processor (104). Another type of user input device is a cursor control (116), such as a mouse, a trackball, or cursor direction keys for communicating direction information and command selections to the processor (104) and for controlling cursor movement on the display (112). This input device typically has two degrees of freedom in two axes, a first axis (e.g., x) and a second axis (e.g., y), that allows the device to specify positions in a plane.

The computer system (100) operates in response to the processor (104) executing one or more sequences of one or more instructions contained in the main memory (106). Such instructions may be read into the main memory (106) from another computer-readable medium, such as a storage device (110). Execution of the sequences of instructions contained in the main memory (106) causes processor (104) to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to the processor (104) for execution. Such a medium may take many forms, including but not limited to, non-volatile media, volatile media, and transmission media. Non-volatile media includes, for example, optical or magnetic disks, such as the storage device (110). Volatile media includes dynamic memory, such as the main memory (106). Transmission media includes coaxial cables, copper wire and fiber optics, including the wires that comprise the bus (102). Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor (104) for execution. For example, the instructions may initially be carried on a magnetic disk of a remote computer. The remote computer can load the instructions into its dynamic memory and send the instructions over a telephone line using a modem. A modem local to the computer system (100) can receive the data on the telephone line and use an infra-red transmitter to convert the data to an infra-red signal. An infra-red detector can receive the data carried in the infra-red signal and appropriate circuitry can place the data on the bus (102). The bus (102) carries the data to the main memory (106), from which the processor (104) retrieves and executes the instructions. The instructions received by the main memory (106) may optionally be stored on the storage device (110) either before or after execution by the processor (104).

The computer system (100) also includes a communication interface (118) coupled to the bus (102). The communication interface (118) provides a two-way data communication coupling to a network link (120) that is connected to a local network (122). For example, the communication interface (118) may be an integrated services digital network (ISDN) card or a modem to provide a data communication connection to a corresponding type of telephone line. As another example, the communication interface (118) may be a local area network (LAN) card to provide a data communication connection to a compatible LAN. Wireless links may also be implemented. In any such implementation, the communication interface (118) sends and receives electrical, electromagnetic or optical signals that carry digital data streams representing various types of information.

The network link (120) typically provides data communication through one or more networks to other data devices. For example, the network link (120) may provide a connection through the local network (122) to a host computer (124) or to data equipment operated by an Internet Service Provider (ISP) (126). The ISP (126) in turn provides data communication services through the world wide packet data communication network now commonly referred to as the “Internet” (128). The local network (122) and the Internet (128) both use electrical, electromagnetic or optical signals that carry digital data streams. The signals through the various networks and the signals on the network link (120) and through the communication interface (118), which carry the digital data to and from computer system 100, are exemplary forms of carrier waves transporting the information.

The computer system (100) can send messages and receive data, including program code, through the network(s), the network link (120) and the communication interface (118). In the Internet example, a server (130) might transmit a requested code for an application program through the Internet (128), the ISP (126), the local network (122) and the communication interface (118). The received code may be executed by the processor (104) as it is received, and/or stored in the storage device (110), or other non-volatile storage for later execution. In this manner, the computer system (100) may obtain application code in the form of a carrier wave.

Variations

In one embodiment, when the virtual keyboard is positioned at the top of the screen rather than below, once a predetermined threshold of user performance has been met, the interface is rotated gradually, in stages, reaching approximately to ninety (90) degrees counterclockwise from vertical, until the virtual keyboard is positioned substantially on a left side of the interface, and the game objects now flow from right to left. The first and second game objects continue to move along the first and second substantially straight trajectories toward the virtual keyboard, only in the second position, this trajectory is to the left, rather than upwards.

A series of visible staff lines defining spaces may then be introduced. These lines and spaces correspond to the trajectories along which the game objects travel toward the virtual keyboard. Thus, the game objects travel along either the lines or the spaces, until colliding with the virtual keyboard at the corresponding key. In one embodiment, the game objects are then gradually morphed into classical musical notation.

It is noted that the game of the present invention can be slowed down and simplified to allow any level user to play. Moreover, in one embodiment, the user can number the game objects to remind him/her of best fingerings during the game. The player can also choose different views and graphic themes to facilitate game play or provide variety. The player can also control the tempo, the complexity of play, the types of feedback and scoring options.

Graphic themes can be overlaid like skins over the grid-like infrastructure of the game. Different backgrounds, game objects, targets and event feedback, can be used. Here are some sample interfaces that might be used. For example,

A. The arriving notes could be depicted as caterpillars that are transformed into singing butterflies if the proper piano key is struck at the right time.

B. The arriving notes could be frogs or some other animal needing to cross river and the keys are spring loaded catapults that shoot them over the road if you hit it just right.

C. The arriving notes could be balloons floating up to be popped as they float by a bridge. (This version should transform into musical notes floating up the staff, and eventually rotating to a horizontal game, completing the illustration of the underlying musical map. This could be a multi-colored version with a rainbow keyboard and corresponding colored balloons in the game will allow people with no notion of white and black key patterns to successfully identify the right keys and play.)

D. The arriving notes could be soccer balls that are moving toward goals and goal keepers who must kick the balls in or away at the right moment.

E. The arriving notes could be trains that need to be switched to the right track at the right moment.

F. The target could be trapdoors and only by pressing the key at the right time does it open so you can catch the game objects.

G. The target could be mouths and only by pressing the key at the right time does it open so you can eat the game objects.

These are just some of the many possible variations, but the central underlying grid that rotates and transforms into a musical staff is the organizing principal of the game. Thus, although the gamepad has been described generally with respect to the shape and design of a kalimba, other instruments may be utilized in lieu of said gamepad. For example, piano, drums, flute, trumpet, viola, violin, guitar, and other instruments may be electrically interfaced with the software and GUI as well.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims. Ultimately, although a virtual piano keyboard (14) is illustrated, it can be any object or image that assists the user to see where or what position, or part of the musical instrument, is to be actuated to achieve the desired note, sound, or beat. Likewise, other instruments may be employed, such as drums, flutes, trumpets, guitars, violins, bells, etc. in place of the gamepad.

What is claimed is:

1. An apparatus for providing musical instruction comprising:
a) a computing element;
b) a display connected to the computing element;
c) a gamepad connected to the computing element; and
d) software for execution on said computing element linking a virtual keyboard displayed on the display when the software is executed on the computing element with actions by a user of the gamepad as part of a game.

2. The apparatus of claim 1, in which the software translates notes of a musical piece into game objects on the display.

3. The apparatus of claim 2, in which the software comprises an interpreter for converting a representation of a musical piece into commands for generating game objects.

4. The apparatus of claim 3, in which commands for generating game objects drive a game object generator.

5. The apparatus of claim 4, in which the game object generator is associated with a library of game objects.

6. The apparatus of claim 5, in which the game object generator is associated with a set of parameters for setting properties of game objects.

7. The apparatus of claim 2, in which the game objects move with time from an initial launch position on the display toward keys of the virtual piano keyboard which correspond to notes of the musical piece.

8. The apparatus of claim 7, in which game objects move along pre-defined trajectories.

9. The apparatus of claim 1, in which the gamepad is in the general shape of a kalimba.

10. A method of using a computer, comprising the step of linking a gamepad connected to the computer with the action of game objects displayed on a display of the computer with respect to a virtual piano keyboard displayed on the display.

11. The method of claim 10, in which game objects are generated for notes of a musical piece stored in a computer readable format.

12. The method of claim 11, in which the musical piece of one of a library of musical pieces is stored on the computer.

13. The method of claim 10, in which the computer readable format is MDI.

14. The method of claim 10, in which a user receives a reward in the form of at least one of an audio playback, a video or graphical animation display or an award of points.

15. The method of claim 14, in which the reward is granted when a user depresses a key of the gamepad within a time window spanning an instant when a game object intersects with the corresponding key of a virtual keyboard.

16. The method of claim 15, in which at least one profile of user information is stored on the computer for each of a plurality of users.

17. The method of claim 15, in which the profile information may include a set of starting options.

18. The method of claim 15, in which a plurality of methods are available for selection by a user, each method comprising at least one song and a plurality of levels of difficulty for each song.

19. The method of claim 18, in which each level of difficulty comprises a plurality of songs and one or more challenges designed to advance skills in a respective area of competence.

20. A computer program product, comprising:
a) a storage medium;
b) a musical instrument;
c) a computer;
d) a display, electrically coupled to the computer; and
e) a computer program stored on the storage medium, the computer program comprising instructions for linking the musical instrument connected to the computer with action of game objects displayed on the display of the computer with respect to a virtual image representing the musical instrument displayed on the display.

21. The computer program product of claim 20, in which the computer program further comprises instructions for generating game objects for notes of a musical piece stored in a computer readable format.

22. The computer program product of claim 21, in which the computer program further comprises instructions for providing a user with a reward in the form of at least one of an audio playback, a video or graphical animation display or an award of points.

23. The computer program product of claim 22, in which the computer program further comprises instructions for granting the reward when a user strikes a key of the musical instrument within a time window spanning an instant when a game object intersects with the corresponding key of the virtual image representing the musical instrument.

24. The computer program product of claim 23, in which the musical instrument is in the general shape of a kalimba.

25. A method of instructing a user to read musical notation through interaction with a graphical user interface and a gamepad, comprising the steps of:
a) generating the graphical user interface, having a first position, including a virtual keyboard positioned substantially at a top portion of the interface, having a plurality of keys, each key having a corresponding tongue on the gamepad;
b) incorporating a music file into the graphical user interface, wherein the music file contains data corresponding to an arrangement of at least a first and a second musical note in sequence, having a rhythmic pattern;
c) directing a first game object, representing the first musical note in the arrangement, upward, in a first substantially straight trajectory, toward a first key on the virtual keyboard, corresponding to the first musical note, such that the first game object will experience a first collision with the first key of the virtual keyboard;
d) directing a second game object, representing the second musical note in the arrangement, upward, in a second substantially straight trajectory, toward a second key on the virtual keyboard, corresponding to the second musical note, such that the second game object will experience a second collision with the second key of the virtual keyboard, according to the rhythmic pattern of the arrangement; and
e) awarding a value to the user based upon the ability of the user to strike the corresponding tongue on the gamepad approximately simultaneously with the first and second collisions.

26. The method of instructing of claim 25, further comprising the steps of:
a) rotating the interface to a second position, approximately ninety (90) degrees counterclockwise, once a predetermined threshold of user performance has been met, such that the virtual keyboard is positioned substantially on a left side of the interface, and the first and second game objects move along the first and second substantially straight trajectories toward the virtual keyboard; and
b) introducing a series of visible staff lines defining spaces, where the lines and spaces correspond to the straight trajectories along which the game objects travel toward the virtual keyboard, such that the game objects travel along either the lines or the spaces, until colliding with the virtual keyboard at the corresponding key.

27. The method of claim 26, further comprising the step of morphing the game objects into classical musical notation.

28. The method of claim 25, in which the gamepad is in the general shape of a kalimba.

29. A method of instructing a user to read musical notation through interaction with a graphical user interface and a gamepad, comprising the steps of:
a) generating the graphical user interface, having a first position, including a virtual keyboard positioned substantially at a top portion of the interface, having a plurality of keys, each key having a corresponding tongue on the gamepad;
b) incorporating a music file into the graphical user interface, wherein the music file contains data corresponding to an arrangement of a plurality of musical notes in sequence, having a rhythmic pattern, each note being represented by a game object;
c) directing the game objects upward, in substantially straight trajectories, toward keys on the virtual keyboard corresponding to the musical notes;
d) colliding the game objects with the corresponding keys according to the rhythmic pattern of the arrangement;
e) awarding a value to the user based upon the ability of the user to strike the corresponding tongue on the gamepad approximately simultaneously with the collisions;
f) rotating the interface to a second position, approximately ninety (90) degrees counterclockwise, once a predetermined threshold of user performance has been met, such that the virtual keyboard is positioned substantially on a left side of the interface, and the game objects continue to move along the substantially straight trajectories toward the virtual keyboard.

30. The method of claim 29, further comprising the step of introducing a series of visible staff lines defining spaces, where the lines and spaces correspond to the straight trajectories along which the game objects travel toward the virtual piano keyboard, such that the game objects travel along either the lines or the spaces, until colliding with the virtual piano keyboard at the corresponding key.

31. A method of musical instruction comprising the step of converting a musical file into animated game objects for display on a screen.

32. The method of claim 31, in which the game objects flow upward on the screen.

33. The method of claim 32, further comprising the step of morphing game objects into musical notation.

34. The method of claim 33, in which trajectories for the game objects rotate between vertical and horizontal.

35. The method of claim 34, in which the game objects flow upward on the screen, morph into musical notation; and rotate from vertical to horizontal.

36. The method of claim 35, in which the game objects are selectively colored.

37. An input gamepad device, which is color coordinated with the game objects and virtual target keyboard, designed to be played with the thumbs while the rest of the fingers hold the device, in the general shape of a kalimba.

38. An input gamepad device, which is color coordinated with the game objects and virtual target keyboard, and includes a built in monitor, CPU, and speakers, such as used in a personal digital game, designed to be played with the thumbs while the rest of the fingers hold the device, in the general shape of a kalimba.
